(19) United States
(12) Patent Application Publication
(10) Pub. No.: US 2011/0099562 A1
(43) Pub. Date: Apr. 28, 2011

(54) Method and System on Chip (SoC) for Adapting a Reconfigurable Hardware for an Application at Runtime

(75) Inventors: SK Nandy, Karnataka (IN); Ranjani Narayan, Karnataka (IN); Mythri Alle, Hyderabad (IN); Keshavan Vardarajan, Karnataka (IN); Alexander Fell, Kreuzau (DE); Adarsha Rao, Karnataka (IN); Ramesh Reddy, Andhra Pradesh (IN); Nimmy Joseph, Kerala (IN)

(73) Assignee: Morphing Machines Pvt Ltd, Bangalore (IN)

(21) Appl. No.: 13/002,329

(22) PCT Filed: Jun. 26, 2009
(86) PCT No.: PCT/IN2009/000367

§ 371 Date: Dec. 31, 2010

(30) Foreign Application Priority Data
Jul. 1, 2008 (IN) 1594/CHE/2008

(51) Int. Cl. G06F 9/54

(52) U.S. Cl. 719/320

(57) ABSTRACT

A method and System on Chip (SoC) for adapting a reconfigurable hardware for an application at run time is provided. The method includes obtaining a plurality of application substructures corresponding to the application. An application substructure performs one or more of a plurality of functions of the application. The method further includes retrieving compute metadata and transport metadata corresponding to each application substructure. Compute metadata specifies functionality of an application substructure and transport metadata specifies data flow path of an application substructure. Thereafter, the method maps each application substructure to a corresponding set of tiles in the hardware. The set of tiles includes one or more tiles and a tile performs one or more of a plurality of functions of the application.

### FIELD OF THE INVENTION

The invention generally relates to Application Specific Integrated Circuits (ASIC). More specifically, the invention relates to a method and system on chip (SoC) for adapting a reconfigurable hardware for an application at runtime.

### BACKGROUND OF THE INVENTION

Embedded systems support a plethora of applications in various domains including, but not limited to, communications, multimedia, and image processing. Such a vast range of applications require flexible computing platforms for different needs of each application and derivatives of each application. General purpose processors are good candidates to support the vast range of applications due to the flexibility they offer. However, general purpose processors are unable to meet the stringent performance, throughput and power requirements of the applications hosted on embedded systems.

Programmable Logic Devices (PLD) on the other hand offers flexible solutions to meet the demands of different applications. The ability of PLDs being programmable has the advantage of providing design flexibility and faster implementation during the system development effort. PLDs include Field Programmable Gate Arrays (FPGA). FPGAs are designed to be programmed by the end user using special-purpose equipment. FPGAs are field-programmable and can employ programmable gates to allow various configurations. The ability of FPGAs to be field-programmable offers the advantage of determining and correcting any errors which may not have been detectable prior to use. However, PLDs, operate at relatively low performance, consume more power, and have relatively high cost per chip. Further, in FPGAs, programming based on applications at runtime is not easily achieved because of the latency caused by each configuration reload whenever there is an application switch.

Unlike traditional desktop devices, embedded platforms have critical performance, throughput and power requirements. The stringent requirements in terms of performance, power, and cost have led to the use of hardware accelerators that perform functions faster than that possible through software. However, flexibility is necessitated by constantly changing market trends, customer requirements, standards specifications, and application features. Several present day embedded applications such as mobile communications, mobile video streaming, video conferencing, live maps etc. demand hardware realizations in the form of Application Specific Integrated Circuit (ASIC) solutions to meet the throughput rate requirements. ASICs enable hardware acceleration of an application by hard coding the functions onto hardware to satisfy the performance and throughput requirements of the application. However, the gain in increased performance and throughput through the use of ASICs is at the loss of flexibility.

Therefore, the hard coded design model of ASICs do not meet changing market demands and multiple emerging variants of applications catering to different customer needs. Spinning an ASIC for every application is prohibitively expensive. The design cycle of an ASIC from concept to production typically takes about 15 months at a cost of $10-15 million. However, the time and cost may escalate further as the ASIC is redesigned and respun to conform to changes in standards, to incorporate additional features, or to match customer requirements. The increased cost may be justified if the market volume for the specific application corresponding to an ASIC is large. However, rapid evolution of technology and changing requirements of applications prohibit any one application optimized on an ASIC from having a significant market demand to justify the large costs involved in producing the ASIC.

Therefore, there is a need for a method and apparatus for adapting a reconfigurable hardware for an application at run time that provides scalability and interoperability between various domain specific applications at run time.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 illustrates a block diagram of a reconfigurable hardware in which various embodiments of the invention may function.

FIG. 2 illustrates architecture of a tile of a reconfigurable hardware for adapting to an application at run time in accordance with an embodiment of the invention.

FIG. 3 illustrates a block diagram of a System on a Chip (SoC) for adapting a reconfigurable hardware for an application at run time in accordance with an embodiment of the invention.

FIG. 4 illustrates a flow chart for a method for adapting a reconfigurable hardware for an application at runtime in accordance with an embodiment of the invention.

FIG. 5 illustrates a flow chart of a method for mapping each application substructure to a corresponding set of tiles in the hardware in accordance with an embodiment of the invention.

FIG. 6 illustrates an exemplary embodiment of a reconfigurable hardware adaptable for an application at runtime.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE INVENTION

Before describing in detail embodiments that are in accordance with the invention, it should be observed that the embodiments reside primarily in combinations of method steps and apparatus components related to adapting a reconfigurable hardware for an application at runtime. Accordingly, the apparatus components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments described herein may be comprised of one or more conventional processors and unique stored program instructions that control the one or more processors to implement, in conjunction with certain non-processor circuits, some, most, or all of the functions of adapting a reconfigurable hardware for an application at runtime. The non-processor circuits may include, but are not limited to, a radio receiver, a radio transmitter, signal drivers, clock circuits, power source circuits, and user input devices.

Various embodiments of the invention provide a method and apparatus for adapting a reconfigurable hardware for an application at run time. A plurality of application substructures corresponding to the application is obtained. An application substructure performs one or more of a plurality of functions of the application. Compute metadata and transport metadata corresponding to each application substructure is retrieved. Compute metadata specifies functionality of an application substructure. Transport metadata specifies a data flow path of an application substructure. Each application substructure is mapped to a corresponding set of tiles in the hardware for configuring the hardware for the application.

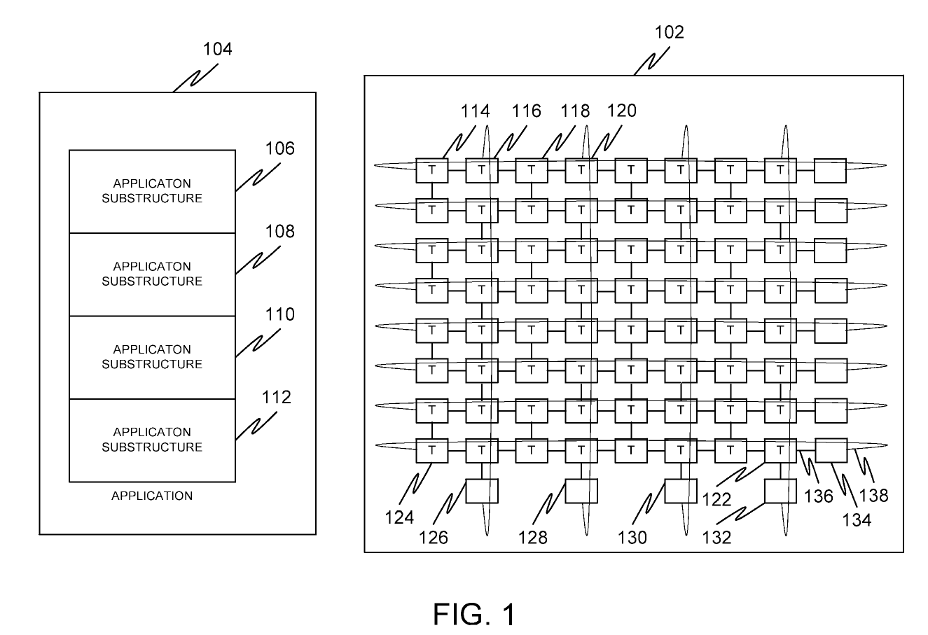

FIG. 1 illustrates a block diagram of a reconfigurable hardware 102 in which various embodiments of the invention may function. Reconfigurable hardware 102 is adaptable to execute an application 104 at runtime. Application 104, can be for example, but is not limited to a multimedia application, a wireless communication application, a gaming application, and a security application. Application 104 includes a plurality of application substructures such as application substructure 106, application substructure 108, application substructure 110, and application substructure 112. Each of the plurality of application substructures performs one or more of a plurality of functions of application 104.

Reconfigurable hardware 102 includes a plurality of tiles such as tile 114, tile 116, tile 118, and tile 120, tile 122, and tile 124. In an embodiment, a tile performs one or more functions of a plurality of functions of application 104. Tiles on reconfigurable hardware 102 form a hardware fabric. In exemplary embodiment, the hardware fabric may consist of, for example, 64 tiles arranged in 8×8 regular structure. In order to perform an operation, interconnections are established among one or more tiles of the plurality of tiles. In an embodiment, the plurality of tiles may be interconnected through a honeycomb topology, as depicted in FIG. 1. The honeycomb topology is chosen as the interconnection network on the hardware fabric as the honeycomb topology has lesser intercommunication per tile than a two-dimensional mesh topology. The reduced intercommunication in the honeycomb topology in turn decreases the complexity of the network router.

Interconnections within reconfigurable hardware 102 are divided into two logical sets. A first set of interconnections facilitates instruction transfer from a controlling entity to boundary tiles. Boundary tiles such as a boundary tile 126, a boundary tile 128, a boundary tile 130, a boundary tile 132, and a boundary tile 134 connect with a tile of the plurality of tiles via an interconnect. For example, boundary tile 134 connects to tile 122 via an interconnect 136, boundary tile 134 connects to tile 124 via an interconnect 138, as depicted in FIG. 1. It will be readily apparent to a person skilled in the art that interconnections between the boundary tiles and tiles of the plurality of tiles are not limited to the interconnection topology illustrated in FIG. 1 but may be extended to include other interconnection topologies. Routers are employed to transmit instructions from the boundary tiles to a destination tile.

A second set of interconnections, connect the tiles in a honeycomb topology. The second set of interconnections is used for intercommunication between multiple tiles and for transfer of instructions within a tile. A routing algorithm is used for routing data along the shortest path to the destination. The honeycomb topology has horizontal links on every alternate node. Therefore, the routing algorithm prioritizes horizontal links over vertical ones. At each router, an output port to which the packet is to be sent is determined based on a relative addressing scheme. For example, X-Y relative addressing scheme may be used for routing.

It will be readily apparent to a person skilled in the art that the tiles may be interconnected through network topologies including but not limited to network topologies such as ring topologies, bus topologies, star topologies, tree topologies, mesh topologies, and diamond topology.

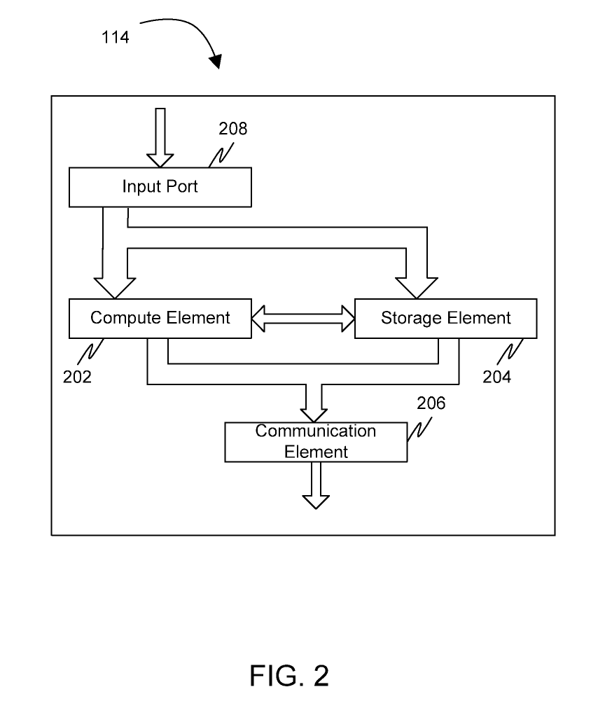

FIG. 2 illustrates architecture of tile 114 of reconfigurable hardware 102 for adapting reconfigurable hardware 102 for an application at run time in accordance with an embodiment of the invention. Tile 114 is an aggregation of elementary hardware resources and includes one or more of one or more compute elements, one or more storage elements, and one or more communication elements. For the sake of clarity, tile 114 as illustrated in FIG. 2 illustrates one compute element 202, one storage element 204, and one communication element 206. However, it is to be noted that tile 114 may include a plurality of compute elements, a plurality of storage elements and a plurality of communication elements without deviating from the scope of the invention.

Compute element 202 is one of an Arithmetic Logic Unit (ALU) and a Functional Unit (FU) configured to execute a primitive function. Compute element 202 processes application 104 received at an input port 208 and takes a finite number of execution cycles to execute the primitive function. Compute element 202 may access storage element 204 during processing of the application by raising a request to storage element 204. Storage element 204 includes a plurality of storage banks and in an embodiment may store intermediate results produced by compute element 202.

Communication element 206 facilitates communications of tile 114 with the one or more tiles on the hardware fabric. After executing the primitive function, compute element 202 asserts an explicit signal to indicate availability of a valid output to communication element 206. Thereafter, communication element 206 routes the valid output to one or more of tiles of the hardware fabric based on requirements of the plurality of applications substructures. Compute element 202 waits for communication element 206 to route the valid output to one or more of tiles before accepting further inputs thereby implementing a producer-consumer model.

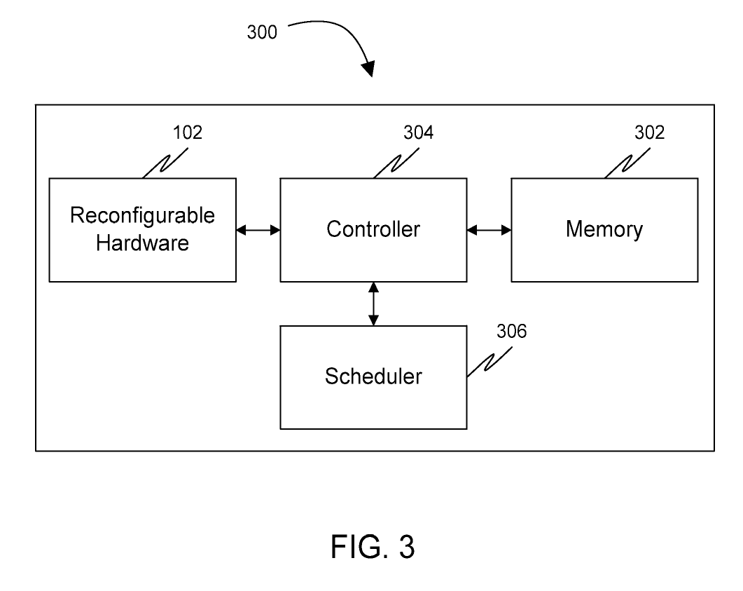

FIG. 3 illustrates a block diagram of a System on a Chip (SoC) 300 for adapting reconfigurable hardware 102 for application 104 at run time in accordance with an embodiment of the invention. As depicted in FIG. 3, SoC 300 includes a memory 302, a controller 304 coupled to memory 302, and reconfigurable hardware 102. In order to initiate the process of reconfiguring reconfigurable hardware 102 for application 104, controller 304 obtains a plurality of application substructures for application 104. An application substructure performs one or more functions of a plurality of functions of application 104.

The plurality of application substructures of application 104 are obtained by transforming high level specifications (HLL) of application 104 in predetermined representation. The predetermined representation can be for example, a static single assignment (SSA) representation. Thereafter, the predetermined representation is processed to obtain the plurality of application structures in a form of a data flow graph. Further, the data flow graph is further divided into one or more sub graphs to obtain the plurality of application substructures. In an embodiment, the plurality of application substructures complies with a plurality of constraints. The plurality of constraints includes one or more of, but is not limited to, a non-existence of cyclic dependencies among each of the plurality of application substructures, number of tiles on reconfigurable hardware 102 to exceed or to equal the number of functions corresponding to application 104.

In an embodiment, an application substructure is associated with a tag for unique identification of each application substructure during execution of each application substructure on reconfigurable hardware 102. A tag may be, for example, a static tag or a dynamic tag. Static tags are used to identify an application substructure when a single instance of producer application substructure and consumer application substructure exist. A static tag may also be used if it is ensured either by adding dependencies or by using hardware support that only a single instance is active. However, in cases where multiple producer application substructures and consumer application substructure may be active simultaneously, a dynamic tag along with the static tag is required. In an exemplary case where multiple producer application substructure exist for a single consumer application substructure then a latest generated tag needs to reach the consumer application substructure.

On obtaining the plurality of application substructures, controller 304 retrieves compute metadata and transport metadata corresponding to each of the plurality of application substructures. Controller 304 retrieves compute metadata and transport metadata corresponding to each of the plurality of application substructures from memory 302. Compute metadata specifies the functionality of each of the tiles required for the execution of operations for the plurality of application substructures. Transport metadata specifies a data flow path and the interconnection between the tiles required for the execution of operations for the plurality of application substructures.

Thereafter, controller 304 maps each application substructure to a corresponding set of tiles in reconfigurable hardware 102 based on a corresponding compute metadata and transport metadata. Compute metadata and transport metadata assist in identifying a set of tiles to form a function block on the hardware fabric at run time corresponding to each application substructure. Each application substructure is mapped to a set of tiles based on one or more compute elements required for performing one or more functions corresponding to an application substructure. Therefore, availability of a set of tiles with required compute elements needs to be established before mapping an application substructure to the set of tiles. In an embodiment, controller 304 evaluates availability of a set of tiles including one or more compute elements required for performing one or more functions of an application substructure.

In an embodiment, an application substructure may be partitioned into multiple partitioned application substructures before mapping to a set of tiles. Thereafter, each of the partitioned application substructures may be mapped to a tile with a corresponding compute element in the set of tiles. Since each tile of the set of tiles executes one operation at an instant of time, better performance may be obtained during parallel execution of operations on different tiles. Alternatively, multiple operations may also be executed on the same tile by pipelining the operations corresponding to the tile. The pipelining of operations may be performed by overlapping computation of succeeding operations during communication of a current operation.

Further, a plurality of application substructures are mapped together on to the corresponding sets of tiles. The plurality of application substructures being mapped together form a custom instruction. Custom instructions enhance efficiency by minimizing the overheads incurred during mapping and execution of the plurality of application substructures. Further, since the plurality of application substructures in a custom instruction are persistent on the hardware fabric, all iterations of loops within a custom instruction reuse a set of tiles. Therefore, only a single iteration is active during any point of time. The iterations corresponding to the plurality of application substructures may be pipelined based on data dependencies between the plurality of application substructures.

Once a set of tiles is identified for each application substructure, controller 304 configures intercommunication between one or more tiles of a set of tiles based on transport metadata corresponding to an application substructure. In an embodiment, controller 304 configures intercommunication within a tile of the set of tile based on transport metadata corresponding to the application substructure. Modifying intercommunications alters the data flow path within a tile and among one or more tiles of a set of tiles and thereby the set of tile is adapted to an application substructure. Thereafter, controller 304 configures intercommunications among the one or more set of tiles corresponding to the plurality of application substructures based on transport metadata corresponding to each application substructure. Thereby the data flow path among the one or more set of tiles is altered as per the requirement of application 104.

SoC 300 further includes a scheduler 306. Scheduler 306 is coupled with controller 304 and is configured to schedule the mapping of plurality of application substructures to the plurality of set of tiles based on predetermined scheduling criteria. The scheduling is based on the predetermined scheduling criteria based on the plurality of application substructures and the resources available. The mapping of each of the plurality of application substructures is scheduled to ensure the resource requirement for the plurality of application substructures are below resource limits.

In an embodiment, scheduler 306 may implement a scheduling algorithm to determine a schedule or mapping of the plurality of application substructures. The scheduling algorithm resolves contention among the plurality of application substructures to be mapped. In order to resolve contention during the mapping of the plurality of application substructures, the scheduling algorithm assigns priority to an application substructure based on predetermined criteria.

In an embodiment, while performing one or more functions, a plurality of set of tiles may exchange input/output with each other using intercommunication paths between the plurality of tiles. In another embodiment, a set of tiles may store the output in memory 302 of SoC 300. Thereafter, another set of tiles may pick the output of the set of tiles from memory 302 when required. Controller 304 may provide information regarding availability of an input/output to the plurality of set of tiles.

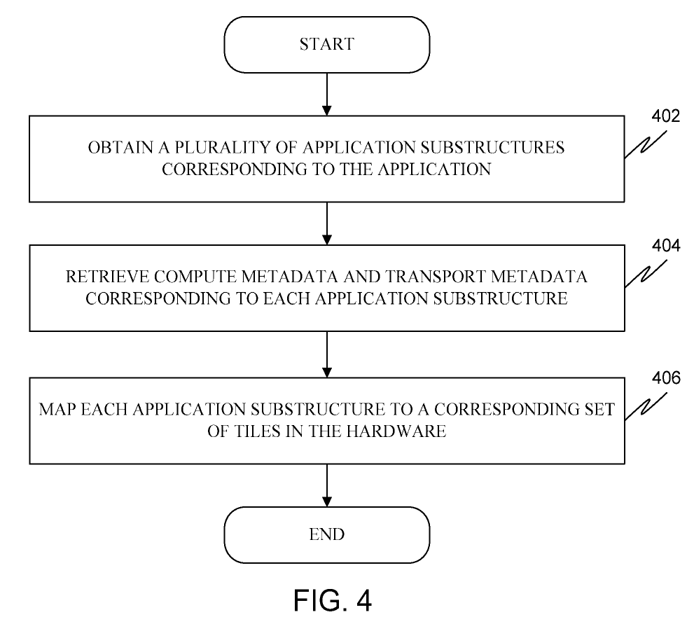

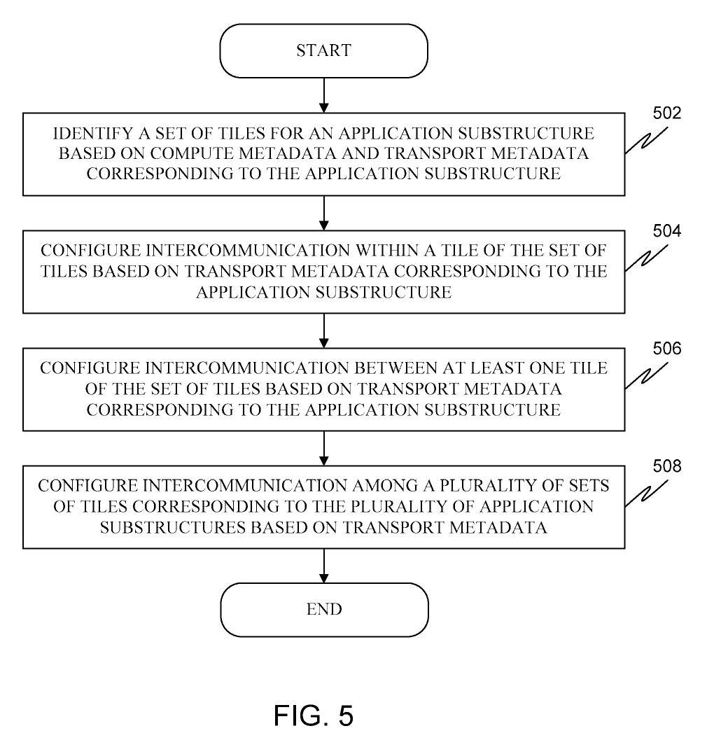

FIG. 4 illustrates a method for adapting reconfigurable hardware 102 for an application at runtime in accordance with an embodiment of the invention. In order to initiate the process of reconfiguring reconfigurable hardware 102 for the application, a plurality of application substructures for application 104 are obtained at step 402. An application substructure performs one or more functions of a plurality of functions of the application. The plurality of application substructures are obtained by transforming high level language (HLL) specifications of the application. On obtaining the plurality of application substructures, compute metadata and transport metadata corresponding to each of the plurality of application substructures are retrieved at step 404. Compute metadata specifies functionality of an application substructure. Transport metadata specifies data flow path of an application substructure. Thereafter, each application substructure is mapped to a corresponding set of tiles in reconfigurable hardware 102 at step 406. This is further explained in detail in conjunction with FIG. 5.

A set of tiles includes one or more tiles. In an embodiment a tile performs one or more functions of the plurality of functions of the application. A tile is an aggregation of elementary hardware resources and includes one or more of one or more compute elements, one or more storage elements, and one or more communication elements. A compute element is one of an Arithmetic Logic Unit (ALU) and a Functional Unit (FU) configured to execute a primitive function. Storage element 204 includes a plurality of storage banks and in an embodiment may store intermediate results produced by the compute element. Communication element facilitates communications of a tile with the one or more tiles on the hardware fabric.

Turning to FIG. 5, a method for mapping the plurality of application substructures to a corresponding set of tiles in reconfigurable hardware 102 is illustrated in accordance with an embodiment of the invention. At step 502, a set of tiles for an application substructure is identified based a corresponding compute metadata and transport metadata. Compute metadata and transport metadata assist in identifying a set of tiles to form a function block on the hardware fabric at run time corresponding to each application substructure. Each application substructure is mapped to a set of tiles based on one or more compute elements required for performing one or more functions corresponding to an application substructure. Therefore, availability of a set of tiles with required compute elements needs to be established before mapping an application substructure to the set of tiles. In an embodiment, availability of a set of tiles including one or more compute elements required for performing one or more functions of an application substructure is evaluated.

Once a set of tiles is identified for each application substructure, at step 504, intercommunication within a tile of the set of tile is configured based on transport metadata corresponding to the application substructure. Thereafter, at step 506, intercommunications between one or more tiles of a set of tiles are configured based on transport metadata corresponding to an application substructure. Modifying intercommunications alters the data flow path within a tile and among one or more tiles of a set of tiles and thereby the set of tiles is adapted to an application substructure. Thereafter, intercommunications among the one or more set of tiles corresponding to the plurality of application substructures is configured based on transport metadata corresponding to each application substructure at step 508. Thereby the data flow path among the one or more set of tiles is altered as per the requirement of the application.

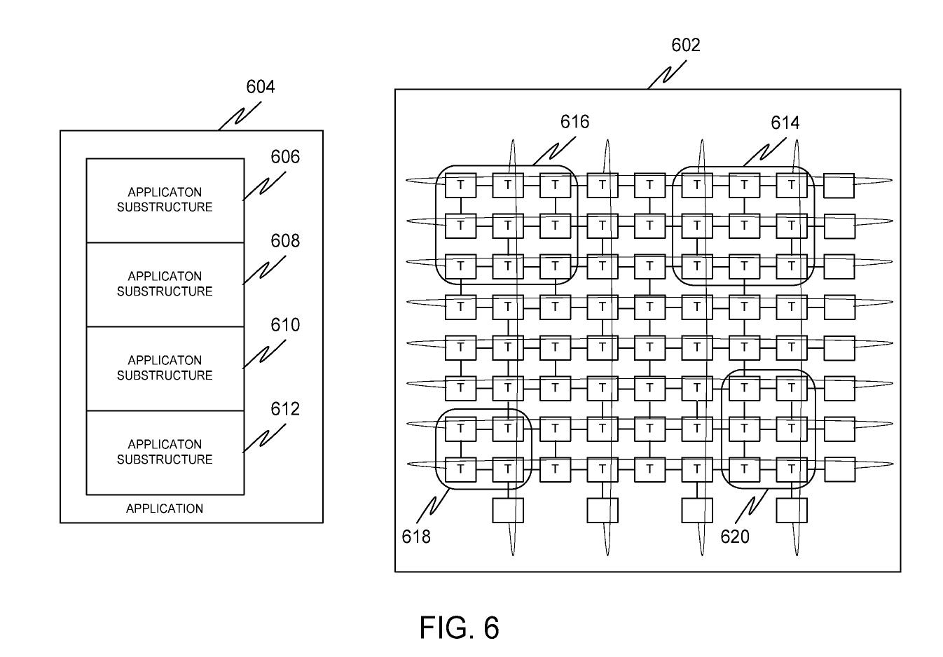

FIG. 6 illustrates an exemplary embodiment of a reconfigurable hardware 602 adaptable for an application 604 at runtime. In order to adapt reconfigurable hardware 602 for application 604, a plurality of application substructures are obtained for application 604. The plurality of application substructures for application 604 includes an application substructure 606, an application substructure 608, an application substructure 610, and an application substructure 612. Each of the plurality of application substructures corresponds to one or more of a plurality of functions of application 604.

Thereafter, controller 304 retrieves compute metadata and transport metadata corresponding to each of the plurality of application substructures from memory 302. Compute metadata and transport metadata assist in identifying a set of tiles to form hardware affines on the hardware fabric at run time. Compute metadata specifies the functionality of each of the tiles required for the execution of operations for an application substructure. Transport metadata specifies a data flow path and the interconnections required between the tiles for the execution of operations for an application substructure.

In response to retrieving compute metadata and transport metadata, controller 304 identifies a set of tiles for each of application substructure 606, application substructure 608, application substructure 610, and application substructure 612. An application substructure is mapped to a set of tiles including one or more compute elements required for performing one or more functions corresponding to the application substructure. Accordingly, controller 304 identifies a set of tiles 614 for application substructure 606, a set of tiles 616 for application substructure 608, a set of tiles 618 for application substructure 610, and a set of tiles 620 for application substructure 612.

Thereafter, each of set of tiles 614, set of tiles 616, set of tiles 618, and set of tiles 620 are configured with respect to the intercommunications within a tile and between one or more tiles in a set of tiles for altering data flow path within a tile and between one or more tiles based on the plurality of application substructures. Each of the set of tiles performs one or more functions in combination to execute the application.

The invention provides a method and a SoC for adapting a runtime reconfigurable hardware for an application. The SoC of the invention maps a plurality of application substructures of the application to a set of tiles. Further, the invention provides a method for configuring the set of tiles for adapting to an application at runtime. Therefore, the invention provides hardware solution for executing application in terms of scalability and interoperability between various application versions.

In the foregoing specification, specific embodiments of the invention have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the dependency of this application and all equivalents of those claims as issued.

What is claimed is:

1. A method for adapting a reconfigurable hardware for an application at runtime, the method comprising:
obtaining a plurality of application substructures corresponding to the application, wherein an application substructure performs at least one function of a plurality of functions of the application;
retrieving compute metadata and transport metadata corresponding to each application substructure, wherein compute metadata specifies functionality of an application substructure and transport metadata specifies data flow path of an application substructure; and
mapping each application substructure to a corresponding set of tiles in the hardware, wherein a set of tiles comprises at least one tile, a tile performs at least one function of the plurality of functions of the application.

2. The method of claim 1, wherein a tile comprises at least one of at least one compute element, at least one storage element and at least one communication element.

3. The method of claim 1, wherein the obtaining comprises:
specifying the application into a high level language (HLL) specification; and
transforming the HLL specification to obtain the plurality of application substructures corresponding to the application.

4. The method of claim 3, wherein the plurality of application substructures complies with a plurality of constraints, wherein the plurality of constraints comprises at least one of a:
non-existence of cyclic dependencies among each of the plurality of application substructures; and
number of tiles on the hardware exceeds or equals to the plurality of functions of the application.

5. The method of claim 1, further comprising scheduling mapping of each application substructure to a set of tiles based on a predetermined scheduling criteria.

6. The method of claim 1, wherein the mapping comprises:
identifying a set of tiles for an application substructure based on compute metadata and transport metadata corresponding to the application substructure;
configuring intercommunication within a tile of the set of tiles based on transport metadata corresponding to the application substructure; and
configuring intercommunication between at least one tile of the set of tiles based on transport metadata corresponding to the application substructure.

7. The method of claim 6, wherein the identifying comprises:
evaluating availability of a set of tiles comprising at least one tile, wherein at least one tile, comprises at least one compute element required for performing at least one function corresponding to the application substructure.

8. The method of claim 6, wherein the mapping further comprises:
configuring intercommunication among a plurality of sets of tiles corresponding to the plurality of application substructures based on transport metadata corresponding to each application substructure of the plurality of application substructures.

9. A system on chip (SoC) for adapting a reconfigurable hardware for an application at run time, the SoC comprises:
a memory; and
a controller, wherein the controller is coupled to the memory, the controller is configured to:
obtain a plurality of application substructures corresponding to the application, wherein an application substructure performs at least one function of a plurality of functions of the application;
retrieve compute metadata and transport metadata corresponding to each application substructure, wherein compute metadata specifies functionality of an application substructure and transport metadata specifies data flow path of an application substructure; and
map each application substructure to a corresponding set of tiles in the hardware, wherein a set of tiles comprises at least one tile, a tile performs at least one function of the plurality of functions of the application.

10. The SoC of claim 9, wherein a tile comprises at least one of at least one compute element, at least one storage element and at least one communication element.

11. The SoC of claim 9, wherein the controller is further configured to:
identify a set of tiles for an application substructure based on compute metadata and transport metadata corresponding to the application substructure;
configuring intercommunication within a tile of the set of tiles based on transport metadata corresponding to the application substructure; and
configure intercommunication between at least one tile of the set of tiles based on transport metadata corresponding to the application substructure.

12. The SoC of claim 10, wherein the controller is further configured to:
evaluate availability of a set of tiles comprising at least one tile, wherein at least one tile comprises at least one compute element required for performing at least one function corresponding to the application substructure.

13. The SoC of claim 9, wherein the controller is further configured to:
configure intercommunication among a plurality of sets of tiles corresponding to the plurality of application substructures based on transport metadata corresponding to each application substructure of the plurality of application substructures.

14. The SoC of claim 9, wherein the controller is further configured to:
facilitate intercommunication among a plurality of set of tiles corresponding to the plurality of application substructures using the memory.

15. The SOC of claim 9, further comprises a scheduler configured to:
schedule mapping of each application substructure to a set of tiles based on a predetermined scheduling criteria.
